(19) United States
(12) Patent Application Publication
(10) Pub. No.: US 2014/0096603 A1
(43) Pub. Date: Apr. 10, 2014

(54) ACCURATE FLUID LEVEL MEASUREMENT DEVICE

(71) Applicants: Boyd M. Nichols, Dubuque, IA (US); David Myers, Dubuque, IA (US); Benjamin P. Koestler, Asbury, IA (US); Christopher J. Meyer, Dubuque, IA (US)

(72) Inventors: Boyd M. Nichols, Dubuque, IA (US); David Myers, Dubuque, IA (US); Benjamin P. Koestler, Asbury, IA (US); Christopher J. Meyer, Dubuque, IA (US)

(21) Appl. No.: 13/646,780

(22) Filed: Oct. 8, 2012

(51) Int. Cl. G01F 23/30

(52) U.S. Cl. 73/305

(57) ABSTRACT

A fluid level measurement system for sensing fluid level in a tank is disclosed that includes a float that moves vertically in the interior of the tank, and a force measuring mechanism coupled to the float that generates an output based on the upward force on the float. The system can include an outer tube where the float is contained in the outer tube. A microcontroller can compute fluid level using the force measuring mechanism output. Altitude and other factors can be accounted for. Exemplary force measuring mechanisms can include a Hall Effect sensor sensing position of a magnet coupled to the float, or a force sensor coupled to the float. The length of the float, or the float and uncompressed spring can be substantially equal to the height of the tank. The float can have a generally uniform or non-uniform outside diameter.

### FIELD OF THE INVENTION

The present invention generally relates to the field of fluid level measurement, and more specifically to a sensor system to accurately measure the fluid level in a tank.

### BACKGROUND OF THE INVENTION

Existing fluid level measurement devices (sometimes called “senders”) are typically either inaccurate, expensive, or have low resolution. One example of the various uses of fluid level measurement devices is the measurement of fuel in a fuel tank. Most fuel senders utilize a float that floats on top of the fuel and a sensing mechanism to determine the position of the float.

Some fuel sender embodiments use sensors having a long arm with one end of the arm coupled to a float and the other end of the arm coupled to a rotary potentiometer. In these embodiments, fuel level changes cause the float to move which causes the arm position to change and the sensed resistance changes with arm position. Other fuel sender embodiments have a long cylindrical tube placed vertically within the fuel tank, and a float is free to move inside the tube. In these embodiments, a sensing mechanism detects the float position within the tube. In implementations using a float inside a tube, the float is allowed to move from top to bottom inside the tube, and the measurement mechanism must function over the full range of float travel, which can be from a few inches to thirty inches or more. Position sensing can be done in several different ways, including but not limited to resistive, linear variable differential transformer (LVDT), and capacitive. Accurate position measurement of the float over long distances is expensive. Low accuracy and/or low resolution position measurement is less expensive, but may fail to meet some requirements.

Still other fuel sender embodiments include a long cylindrical tube placed vertically within a fuel tank, a float with an attached magnet that is free to move inside the tube, and a series of reed switches arranged inside the tube such that the switch closest to the magnet is always closed. In these embodiments, a resistor in series with each reed switch provides a resistance value which changes with fluid level. However, the resolution of these systems depends on the number of reed switches and the change in fuel level between reed switches. For example, if there are only ten switches equally spaced in a uniform cylindrical fuel tank, then the fluid level can only be determined in increments of approximately 10%. This type of fuel sender system also requires one or more electronic modules to be powered in order to measure fluid level. This imposes a load on the battery and makes it impractical to have the sender operate continuously.

A fuel sender system is just one example of a fluid level measurement system. It would be desirable to have a fluid measurement system with better accuracy, higher resolution, and/or lower power requirements allowing it to operate continuously.

### SUMMARY

A fluid level measurement system for sensing a fluid level in a tank is disclosed that includes a float and a force measuring mechanism. The float moves vertically in the tank, for example by being contained within an outer tube that extends vertically in the tank. The float extends from the bottom of the tube to close to the top of the tube, and is free to move vertically within the outer tube. The float exerts an upward force which increases in proportion to the volume of the fluid displaced by the float, which is also in proportion to the fluid level in the tank. The force measuring mechanism is coupled to the float, and the force measuring mechanism generates an output based on the upward force on the float due to the fluid level in the tank.

The fluid level measurement system can also include a microcontroller that receives the output of the force measuring mechanism and computes the fluid level in the tank using the output of the force measuring mechanism.

The upward force varies with the weight of the fluid. Fluid weight can vary for different reasons, for example it can vary with altitude, where the force of gravity gradually diminishes with altitude. The fluid level measurement system can also include an altitude measuring mechanism, such as an accelerometer to measure changes in gravity, and the microcontroller can use this measurement to apply a correction factor to account for changes in gravitational force.

The upward force on the float can also change with the specific gravity of the measured fluid itself. Changes in the specific gravity of the fluid can occur, for example, when the user changes the type of diesel fuel from Diesel 1 to Diesel 2. Changes in specific gravity can be accounted for if one assumes that the tank is always filled completely. With this assumption, the upper position can be re-calibrated with each filling. To guard against a partial filling, the upper position can remain unchanged when the new fill point is below the previous fill point by more than a threshold amount. The microcontroller can use readings from recalibrating the tank upon a fill cycle to compute the fluid level in the tank between a full fluid level and an empty fluid level.

The fluid level measurement system can include a tri-axial accelerometer to compensate for readings when the force measuring mechanism is off of vertical with respect to gravity. The vertical orientation is where the full upward force acts upon the force measuring mechanism. The microcontroller can use readings from a tri-axial accelerometer to compute a correction factor used in determining the fluid level in the tank.

The force measuring mechanism can convert a large change in fluid level into a much smaller position change, facilitating simple and accurate methods of converting fluid level to an electrical signal. The force measuring mechanism can include a spring coupled to the top of the float, a magnet coupled to the spring, and a Hall Effect sensor sensing the position of the magnet and generating an output related to the position of the magnet. The length of the float and the uncompressed length of the spring can be substantially the same as the distance between the fluid level for an empty tank and the fluid level for a full tank. By appropriately scaling the spring force and extent of spring compression, the spring can be fully relaxed with an empty tank and fully compressed with a full tank. The fluid level measurement system can include a microcontroller that receives the output of the Hall Effect sensor and computes the fluid level in the tank using the output of the Hall Effect sensor.

Any measurement methods for detecting the upward force may be used, with the force measuring mechanism having a force sensor coupled to the top of the float, the force sensor generating an output related to the upward force exerted by the float. The length of the float can be substantially the same as the distance between the fluid level for an empty tank and the fluid level for a full tank. The fluid level measurement system can include a microcontroller that receives the output of the force sensor and computes the fluid level in the tank using the output of the force sensor. The force measuring mechanism can also include a spring coupling the pressure sensor to the top of the float.

The float can have a generally uniform or a generally non-uniform outside diameter from top to bottom. The float can have a tapered outside diameter where the outside diameter of the top of the float is less than the outside diameter of the bottom of the float. Tapering the float can be done to compensate for a non-uniform fuel tank such that the force on the spring is linearly proportional to the fuel in the tank, not the position of the float. For example, a tank that is narrow at the top and wide at the bottom can be compensated for by a float that is wide at the top and narrow at the bottom. The bottom of the float can rest at substantially the same level as the bottom end of the outer tube when the tank is empty. The bottom end of the outer tube can substantially coincide with the bottom of the tank. The outer tube can include holes allowing fluid to enter and exit the interior of the outer tube. The outer tube and float can be made of materials unaffected by the fluid in the tank.

### BRIEF DESCRIPTION OF THE DRAWINGS

FIG. 1 shows an exemplary fuel sender;

FIG. 2 shows an exemplary fuel sender with an alternative float shape; and

FIG. 3 shows an exemplary fuel sender using a force sensor.

### DETAILED DESCRIPTION

For the purposes of promoting an understanding of the principles of the novel invention, reference will now be made to the embodiments described herein and illustrated in the drawings and specific language will be used to describe the same. It will nevertheless be understood that no limitation of the scope of the novel invention is thereby intended, such alterations and further modifications in the illustrated devices and methods, and such further applications of the principles of the novel invention as illustrated therein being contemplated as would normally occur to one skilled in the art to which the novel invention relates.

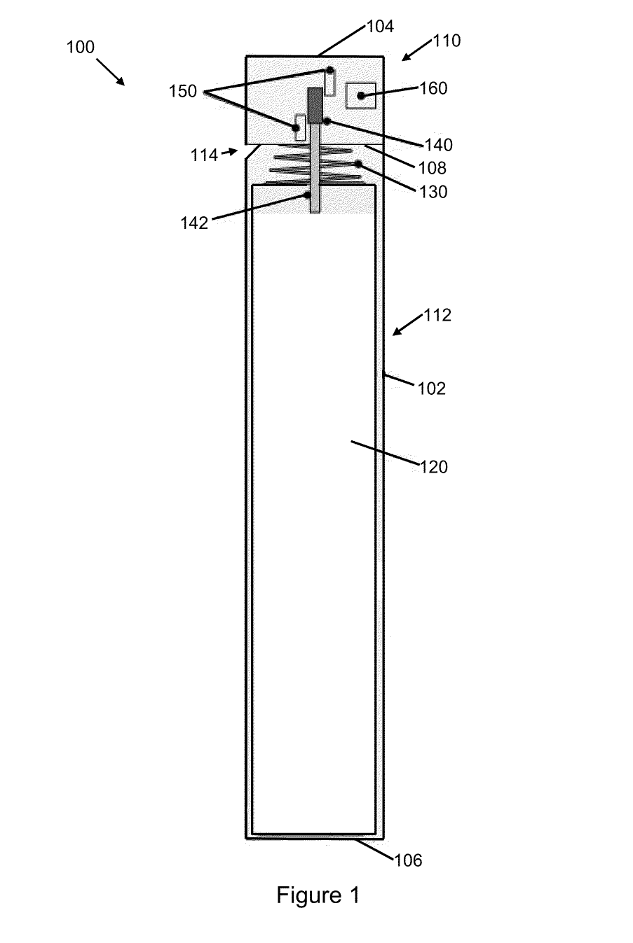

FIG. 1 illustrates an exemplary embodiment of a fluid level measurement device 100 comprising a tube 102, a float 120, a spring 130, a magnet 140, Hall effect sensors 150 and a controller 160. The tube 102 has a generally cylindrical shape extending from a top end 104 to a bottom end 106 of the tube 102. In this embodiment, the tube 102 includes a divider 108 separating the interior of the tube 102 between a sensor area 110 extending from the divider 108 to the top end 104 and a float area 112 extending from the divider 108 to the bottom end 106. The sensor area 110 houses the sensor 140 and the controller 150. The float area 112 extends from substantially the top of the tank to substantially the bottom of the tank containing the fluid to be measured. The float area 112 is the area where the float 120 moves in the interior of the tube 102 in proportion to fluid level in the tank. The bottom end 106 of the tube 102 is open and the top end 104 of the tube 102 can be closed. The surface of the tube 102 in the float area 112 can include holes to allow the fluid to freely enter and exit the interior of the tube 102 in the float area 112. The upper portion of the float area 112 of the tube 102, near the sensor area 110, can include one or more breathing holes 114 which allow fluid or air to enter and exit the interior of the float area 112 as the float 120 moves within the tube 102. The tube 102 can have an exemplary inside diameter of 25 to 50 mm, though other diameters can be selected. The tube 102 can be made of aluminum, plastic or other material not affected by the fluid being measured, for example diesel fuel, urea, hydraulic fluid, etc.

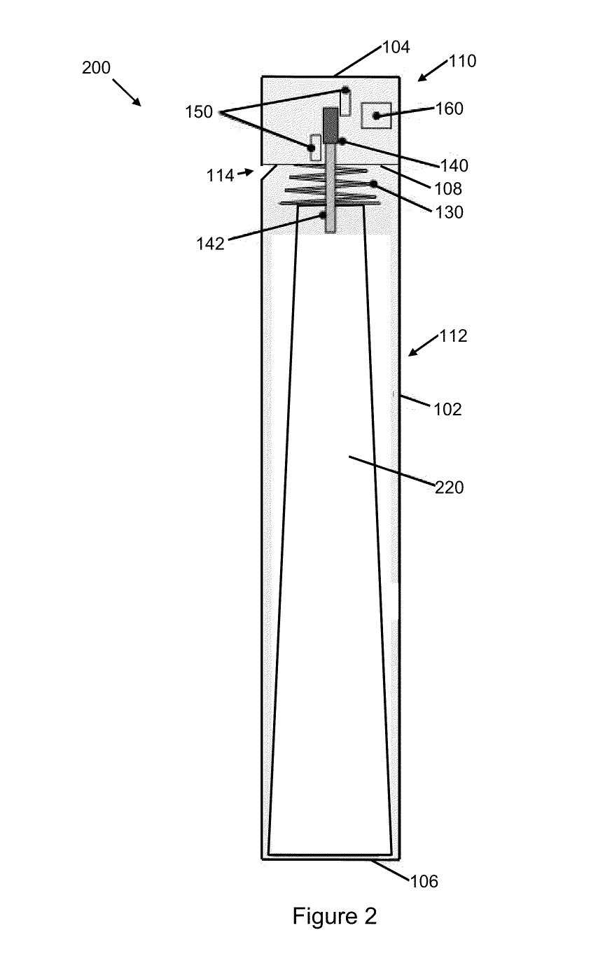

The float 120 is located inside the tube 102 and can freely move or float vertically inside the float area 112 of the tube 102. The float 120 can have a generally uniform outside diameter that is slightly smaller than the inside diameter of the tube 102 as shown by the outside diameter of the float 120 shown in FIG. 1. The float can also have other outside shapes as shown by the float 220 in an alternative fluid measurement system embodiment 200 illustrated in FIG. 2. The float 220 has a tapered shape, tapering from a wider outside diameter near the bottom 106 of the tube 102 to a narrower outside diameter near the divider 108 of the tube 102. The tapered shape of the float 220 can provide greater resolution when the fluid level in the tank approaches empty or can provide compensation for a non-uniform fluid tank. The length of the float 120, 220 can be a few millimeters shorter than the float area 112 of the tube 102. The bottom of the float 120 can be approximately even with the bottom 106 of the tube 102 when the fuel tank is empty to allow the fuel sender 100 to be accurate at very low fluid levels. The float 120, 220 can be made of a lightweight material that is not affected by the fluid being measured. The remaining description will refer to the float 120 of FIG. 1 but applies also to the float 220 of FIG. 2 as well as floats with various alternative shapes.

The spring 130 is located between the divider 108 at the top of the float area 112 and the float 120. As the fluid level changes in the fuel tank, the float 120 will push against the spring 130 with a force roughly equal to the weight of the fluid being displaced by the float 120. The float 120 can be shaped to compensate for nonlinear fuel tanks or to provide higher resolution at certain fuel level ranges (for example, when near empty). In some embodiments, software used by the fluid level measurement system can be used to compensate for non-uniform shaped tanks The spring 130 is compressed based on the fluid level in the tank, and thus exerts an upward force based on the fluid level in the tank. The spring 130 can be made of a material that is not affected by the fluid being measured. The height of the spring 130 can be selected so that there is no force exerted by the spring when the tank is empty. The height of the uncompressed spring 130 and the float 120 can be approximately the same as the height of the float area 112 of the tube 102 which can be approximately the height of the tank over which fluid level is to be measured.

The magnet 140 is coupled to the top of the float 120 and one or more Hall Effect sensors 150 can be used to measure the position of the magnet 140. In the embodiments of FIGS. 1 and 2, a non-magnetic post 142 that extends through the divider 108 is used to couple the magnet 140 to the top of the float 120. The magnet 140 is coupled to the upper end of the post 142 in the sensor area 110, and the float 120 is coupled to the lower end of the post 142 in the float area 112.

When no fluid is present in the tank, the float 120 is at its lowest point and the spring 130 is least compressed or not compressed. When the tank is full of fluid, the float 120 is at its highest point and the spring 130 is most compressed. The degree of compression of the spring 130 is directly proportional to the level of the fluid and can be used to measure the level of fluid in the tank. The spring rate of the spring 130 can be selected such that the magnet 140 is approximately midway between the two Hall Effect sensors 150 when the fluid level in the tank is halfway between full and empty. Two Hall Effect sensors 150 can be used for greater accuracy; however one Hall Effect sensor 150 can be used. The output voltage of the Hall Effect sensor(s) 150 can be measured when the tank is full and empty, and these output voltages can be used as calibration points.

The fluid level measurement systems 100, 200 compress the full fluid level range from empty to full in the tank, which can for example be several tens of centimeters, into a smaller range of movement of the magnet 140, which can for example be twenty or fewer millimeters. The microcontroller 160 receives the output signals from the Hall effect sensor(s) 150 and provides a measurement of fluid level in the tank. By careful design of the sensing mechanism for low power, the sensing mechanism can remain powered continuously.

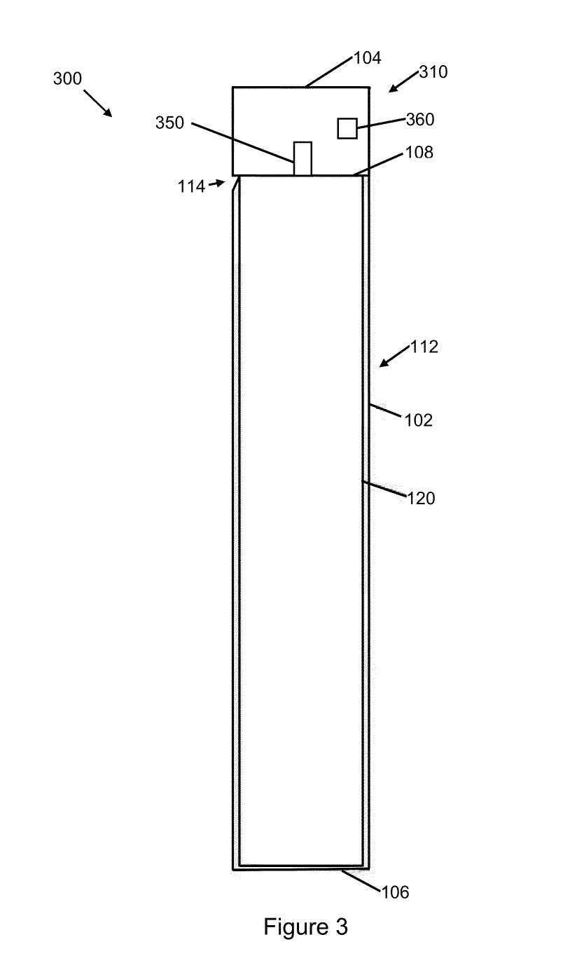

In the fluid level measurement systems 100, 200, the fluid in the tank exerts an upward force on the float 120 equivalent to the weight of the fluid displaced by the float 120, this upward force compresses the spring 130 which moves the magnet 140 and the position of the magnet 140 is measured by the Hall Effect sensors 150. Alternative methods can be used to measure the upward force on the spring 130 to measure the fluid level in the tank. For example, FIG. 3 illustrates a fluid level measurement system 300 with an alternative arrangement in a sensor area 310 and a similar arrangement in the float area 112. The fluid level measurement system 300 includes the tube 102 separated by the divider 108 into the float area 112 and the sensor area 310. The float area 112 houses the float 120. The sensor area 310 houses a microcontroller 360 and a force or pressure sensor 350 that responds to changes in force exerted by the fluid on the float 120. The pressure sensor 350 can be similar to a pressure sensor found in an electronic bathroom scale. The microcontroller 360 receives the output signals from the pressure sensor 350 and provides a measurement of fluid level in the tank.

Embodiments of the fluid level measurement systems 100, 200, 300 can also not include the outer tube 102 surrounding the float 120, 200 but have other means to maintain vertical movement of the float 120, 220. These embodiments also use the upward force on the float 120, 220 to measure the fluid level in the tank.

Calibration methods can be implemented in the software or firmware that process the output readings of the various fluid level measurement sensors. For example, the weight of the fluid displaced by the float 120 decreases at higher altitudes, resulting in a slight but predictable change in the output level measured by the fluid level measurement systems 100, 200, 300. This can be compensated for by using an accelerometer or other device to estimate altitude, and then applying a correction factor to the output level measured by the fluid level measurement system.

Calibration methods can also be used to compensate for fluid level readings when the tank and/or fluid level measurement system 100, 200, 300 is off of vertical with respect to gravity. For example, the fuel tank of a vehicle that traverses hills and other non-level terrain. The vertical orientation is where the full upward force acts upon the force measuring mechanism. The fluid level measurement system 100, 200, 300 can include a tri-axial accelerometer or other vertical orientation device to provide orientation readings used to determine the orientation of the fluid level measurement system with respect to vertical. The microcontroller 160, 360 can use these readings to compute a correction factor to account for the non-vertical orientation and apply the correction factor to the output level measured by the fluid level measurement system.

Calibration methods can also be used to account for the changes in the properties of the spring 130, the pressure sensor 350 or other components of the fluid level measurement systems 100, 200, 300. These calibration methods can also be used to compensate for changes in the fluid used in the tank, for example if the fluid changes between Diesel 1 and Diesel 2 fuel during different times of year. In one exemplary calibration method, the system can assume that whenever the fuel level is increased above, or within a threshold of, the prior full tank fluid level, then the tank is assumed to be full and the new reading (force, position, etc.) can be used as the full tank level. It is usually desirable to have a substantially zero or slightly negative force or pressure on the float 120 when the fuel tank is empty, for example if the float 120 is resting on the bottom 106 of the tube 102 or on the bottom of the tank. This empty tank reading can be assumed to not change. When a new full tank level is obtained, then the system can recalibrate the fluid level range between the new full tank reading and the empty tank reading to account for changes in the properties of the fluid or the components of the fluid level measurement system. The recalibration can also take into account any variations due to the shape of the float (for example, float 220) or the shape of the fluid tank or other factors affecting the scaling between empty and full fluid level readings.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains.

We claim:

1. A fluid level measurement system for sensing a fluid level in a tank, the fluid level measurement system comprising:
a float located in the interior of the tank, the float moving vertically within the tank and exerting an upward force based on the fluid level in the tank; and
a force measuring mechanism coupled to the float, the force measuring mechanism generating an output based on the upward force on the float due to the fluid level in the tank.

2. The fluid level measurement system of claim 1, further comprising a microcontroller that receives the output of the force measuring mechanism and computes the fluid level in the tank using the output of the force measuring mechanism.

3. The fluid level measurement system of claim 2, further comprising an outer tube extending vertically in the tank, the outer tube having a top end and a bottom end, the float being contained in the outer tube.

4. The fluid level measurement system of claim 3, further comprising an altitude measuring mechanism generating an altitude output, the microcontroller receiving the altitude output and using the altitude output in computing the fluid level in the tank.

5. The fluid level measurement system of claim 3, wherein the microcontroller computes the fluid level in the tank between a full fluid level and an empty fluid level, the microcontroller occasionally resetting the full fluid level.

6. The fluid level measurement system of claim 5, wherein the microcontroller resets the full fluid level to equal the computed fluid level when sensing an increase in the computed fluid level and the computed fluid level is greater than or substantially equal to the prior full fluid level.

7. The fluid level measurement system of claim 3, wherein the outer tube includes holes allowing fluid to enter and exit the interior of the outer tube.

8. The fluid level measurement system of claim 3, further comprising a vertical orientation device generating orientation readings, the microcontroller receiving the orientation readings, computing a correction factor to account for any non-vertical orientation, and using the correction factor in computing the fluid level in the tank.

9. The fluid level measurement system of claim 1, wherein the force measuring mechanism measures a position over a reduced range, the reduced range being substantially less than the fluid level range between an empty tank and a full tank.

10. The fluid level measurement system of claim 9, further comprising an outer tube extending vertically in the tank, the outer tube having a top end and a bottom end and a divider located between the top end and the bottom end, the float being contained in the outer tube between the divider and the bottom end of the outer tube; and
wherein the force measuring mechanism comprises:
a spring positioned between the top of the float and the divider;
a magnet coupled to the top of the float; and
a Hall Effect sensor sensing the position of the magnet and generating an output related to the position of the magnet.

11. The fluid level measurement system of claim 10, wherein the length of the float and the uncompressed length of the spring are substantially the same as the distance between the fluid level for an empty tank and the fluid level for a full tank.

12. The fluid level measurement system of claim 10, further comprising a microcontroller that receives the output of the Hall Effect sensor and computes the fluid level in the tank using the output of the Hall Effect sensor.

13. The fluid level measurement system of claim 1, wherein the force measuring mechanism comprises a force sensor coupled to the top of the float, the force sensor generating an output related to the upward force exerted by the float.

14. The fluid level measurement system of claim 13, wherein the length of the float is substantially the same as the distance between the fluid level for an empty tank and the fluid level for a full tank.

15. The fluid level measurement system of claim 13, further comprising a microcontroller that receives the output of the force sensor and computes the fluid level in the tank using the output of the force sensor.

16. The fluid level measurement system of claim 13, wherein the force measuring mechanism further comprises a spring coupling the force sensor to the top of the float.

17. The fluid level measurement system of claim 1, wherein the float has a generally uniform outside diameter from top to bottom.

18. The fluid level measurement system of claim 1, wherein the float has a generally non-uniform outside diameter from top to bottom.

19. The fluid level measurement system of claim 18, wherein the float has a tapered outside diameter, the outside diameter of the top of the float being less than the outside diameter of the bottom of the float.

20. The fluid level measurement system of claim 1, wherein the bottom of the float rests at substantially the bottom of the tank when the tank is empty.
